(19) United States
(12) Patent Application Publication
(10) Pub. No.: US 2024/0311678 A1
(43) Pub. Date: Sep. 19, 2024

(54) Anonemis Research 2302

(71) Applicant: Renee Simenona Martinez, Beverly Hills, CA (US)

(72) Inventor: Renee Simenona Martinez, Beverly Hills, CA (US)

(73) Assignee: Renee Simenona Martinez, Beverly Hills, CA (US)

(21) Appl. No.: 18/122,122

(22) Filed: Mar. 16, 2023

(51) Int. Cl. G06N 10/80; A43B 13/14; B62D 31/00; G06F 16/951; G06F 21/45; G06Q 50/26; G06T 11/60; H04L 9/40; H04N 7/18

(52) U.S. Cl. CPC G06N 10/80; A43B 13/14; B62D 31/00; G06F 16/951; G06F 21/45; G06Q 50/26; G06T 11/60; H04L 63/20; H04N 7/18; G06T 2210/22

(57) ABSTRACT

An embodiment of software that has a critical interface and contains an algorithm for recording micropatterns, as well as essential elements of tactical process procedures within the application for various sectors which requires of Quantum Operation Supremacy to perform such calculations.

### APPLICATION AND METHODOLOGY

Neurological Profiles For Market Matching And Stimulus Presentation/16/561980
Pattern-based Classification/16/912009
Unusual Score Generators For A Neuro-linguistic Behavioral Recognition System/17/164210

### SYSTEM AND METHOD FOR GENERATING CURATED INTERVENTIONS IN RESPONSE TO PATIENT BEHAVIOR/17/213164

Generating Ratings Predictions Using Neuro-response Data/16/152980
System, Method, And Computer Program Product For Analog And Mix-signal Circuit Placement/16/238274

### USER BEHAVIORAL ANALYTICS FOR SECURITY ANOMALY DETECTION IN INDUSTRIAL CONTROL SYSTEMS/17/442834

Span Pointer Networks For Non-autoregressive Task-oriented Semantic Parsing For Assistant Systems 17/525510
Personalized Content Delivery Using Neuro-response Priming Data/16/193930

### ENHANCED RISK ASSESSMENT/17/039009

Training A Machine Learning System For ADC Compensation/16/933617
Efficient Memory Leak Detection In Database Systems/18/169271
Sharing Probabilities For User Traits/15132192
Compositions And Methods For Detecting Predisposition To Cardiovascular Disease/17/857723
Medical Image Analysis Method, Medical Image Analysis Device, And Medical Image Analysis System/17515466
Methods For Diagnosing An Autistic Spectrum Disorder/16/967361
Health And Wellness Management Technology/16/891403
Sensor Device And Methods/16/471552
Systems, Methods And Apparatuses Of Digital Assistants In An Augmented Reality Environment And Local Determination Of Virtual Object Placement And Apparatuses Of Single Or Multi-directional Lens As Portals Between A Physical World And A Digital World Component Of The Augmented Reality Environment/16/853815

### NEUROLOGICAL REHABILITATION AND TRAINING METHOD UTILIZING OCULOMOTOR, VISUAL AND/OR VESTIBULAR REHABILITATION TASKS ON SUBJECTS WITH PHARMACOLOGICALLY INDUCED NEUROPLASTICITY/17/316077

Interactive And Analytical System That Provides A Dynamic Tool For Therapies To Prevent And Cure Dementia-related Diseases/17/676562
Molecule Counting Of Methylated Cell-free DNA For Treatment Monitoring/18/187578
Management Of Connected Sensor Devices/17/390811
Machine Learning Model To Determine A Proper Subset Of A Multimedia File For A Viewer Based On Their Interest/17/521668
Rule Creation For Code Analysis/17/850583
Methods, Systems, And Computer Readable Media For Suppressing Cookie Based Advertisement Retargeting/15/374653
Technique For Alignment Of A Mobile Device Orientation Sensor With The Earth's Coordinate System/16/298410
Mapping Non-attached Subnetworks/16/692034
Batch Normalization For Replicated Layers Of Neural Network/16/923006
Error And Manipulation Resistant Search Technology/16/886986
Batch Normalization For Replicated Layers Of Neural Network/16/923006

### STATEMENT REGARDING FEDERALLY SPONSORED RESEARCH OR DEVELOPMENT:

N/A

### THE NAMES OF THE PARTIES TO A JOINT RESEARCH AGREEMENT

Renee Simenona Martinez, Anonemis Research, and Scigenity Technology

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Standard Application Requirements.

### STATEMENT REGARDING PRIOR DISCLOSURES BY THE INVENTOR OR A JOINT INVENTOR

Invention has not been disclosed.

### BACKGROUND OF THE INVENTION

(1) Field of the Invention: The present application relates to the embodiment of a software application and methodology procedure with a critical outcome process, as it relates to quantum science, and various tactical areas. This software application includes a user-interface with a customized operating system which yields to areas of telecommunications, automotives, transistors, data analysis, behavioral science and quantum approximation.
(2) Description of Related Art including information disclosed under 37 CFR 1.97 and 1.98 N/A

### BRIEF SUMMARY OF THE INVENTION

Quantum Operation Supremacy is an embodiment comprising of an algorithmic software process and system which works by implementing artificial qubits to source and produce calculation data for equation execution.

The use of traditional binary single qubit output methodology is the baseline for this operation and in the alteration regarding quantum operation. The data is stored and categorized into more ridged data columns to eliminate error and to achieve simplification.

Further objects, features, advantages and properties of this software and methodology according to the present application will become apparent from the detailed description.

### BRIEF DESCRIPTION OF THE SEVERAL VIEWS OF THE DRAWING(S)

In the following detailed portion of the present description, the teachings of the present application will be explained in more detail with reference to the example embodiments shown in the drawings, in which:

No Drawings included in this application.

### DETAILED DESCRIPTION OF THE INVENTION

The first embodiment comprises of a system that works by implementing artificial qubits to source and produce calculation data for equation execution. The data is stored and categorized into more ridged data columns to eliminate error and to achieve simplification. Sorting data by patterned repetitions in the level of importance and relevance for desired outcome. The operating user interface includes several of the elements for an interactive precision experience.

In the present embodiment the rapid data shuffling and detecting repetition sources regarding patterns can assist solving complex cryptology. Artificial qubits have infinite potential for quantum calculations. The use of frequency detection can discern the slightest alteration, or manipulation within the quantum monitoring system.

In the present embodiment, this is an advancement towards code breaking within algorithmic systems such a reversal of Shor's algorithm, as well as CAPTCHA generated processes.

The teaching of the present application has numerous advantages. Different embodiments or implementations may yield one or more of the following advantages. It should be noted that this is not an exhaustive list and there may be other advantages which are not described herein the present application.

The invention claimed is:

1. Software process with a critical interface, wherein compromising of an embodiment of an algorithm that records micropatterns, and essential elements of tactical process procedures is provided in various sections of the present application, which require Quantum Operation Supremacy to perform such calculations.

2. A software process and methodology according to claim 1, wherein compromising of specialized algorithm procedure to determine computation results in Digital Licensing concerning Airplanes, Vehicle, and Vessel. Digital licensing and specialized plates and GPS for motor vehicles as well as other transportation mechanisms.

3. A software process and methodology according to claim 1, wherein compromising of specialized algorithm procedure to determine computation results in Cryosilicone Transistors. Cryosilicone Transistors Chip and system mechanism which runs on a circulating fanbelt within a with insulated tubing which prevents the area from heating and to maintain the desired temperature of about −273 degrees Celsius.

4. A software process and methodology according to claim 1, wherein compromising of specialized algorithm procedure to determine computation results in Switchnication. This operation enforces the use of quantum communication channeling methodology to generate frequency tiers for communication and effective tools for security.

5. A software process and methodology according to claim 1, wherein compromising of specialized algorithm procedure to determine computation results in Quantumuency Woodland. The use of quantum estimation theory to approximate the needed materials required for each laboratory investigation in national parks and wooded areas.

6. A software process and methodology according to claim 1, wherein compromising of specialized algorithm procedure to determine computation results Quantumuency Oceanography. The use of quantum estimation theory to approximate the needed materials required for each laboratory investigation in oceanography.

7. A software process and methodology according to claim 1, wherein compromising of specialized algorithm procedure to determine computation results in Retroactive Data Extraction Analysis. This software is designed to operate in a crawl and spider automation in conjunction with data backload and caches from prior operating systems and social platforms both distinct and modified.
